(19) United States
(12) Patent Application Publication
(10) Pub. No.: US 2026/0185832 A1
(43) Pub. Date: Jul. 2, 2026

(54) APPARATUS AND METHOD FOR USER-CUSTOMIZED DYNAMIC PROMPTING FOR WALKING GUIDANCE

(71) Applicant: ELECTRONICS AND TELECOMMUNICATIONS RESEARCH INSTITUTE, Daejeon (KR)

(72) Inventors: Byung-Ok HAN, Daejeon (KR); Woo-Han YUN, Daejeon (KR)

(21) Appl. No.: 19/373,985

(22) Filed: Oct. 30, 2025

(30) Foreign Application Priority Data
Dec. 31, 2024 (KR) 10-2024-0202152

(51) Int. Cl. G01C 21/20; G06F 40/40; G06V 10/25; G06V 20/52

(52) U.S. Cl. CPC G01C 21/20; G06F 40/40; G06V 10/25; G06V 20/52

(57) ABSTRACT

Disclosed herein is an apparatus and method for user-customized dynamic prompting for walking guidance. The method may include generating a text prompt to be input to a vision-language model based on real-time sensor information and history information pertaining to a user and obtaining walking guidance information by inputting an image capturing a walking environment, destination information within the image, and the text prompt to the vision-language model.

### CROSS REFERENCE TO RELATED APPLICATION

This application claims the benefit of Korean Patent Application No. 10-2024-0202152, filed December 31, 2024, which is hereby incorporated by reference in its entirety into this application.

### BACKGROUND OF THE INVENTION

### 1. Technical Field

The disclosed embodiment relates technology for providing walking guidance to a user.

### 2. Description of Related Art

Conventional navigation guidance mainly utilizes preconstructed vehicle maps and GPS sensors for vehicle driving in order to find effective routes to destinations and provide users with guidance that is easy to understand. However, vehicle navigation provides users with directions and distances to destinations based on statically constructed maps, so it is not suitable for being directly applied to pedestrian guidance, which involves more complex and dynamic situations than vehicle roads.

### SUMMARY OF THE INVENTION

An object of the disclosed embodiment is to improve the effectiveness and suitability of guidance on a walking route in complex and dynamic environments by considering various factors, such as a user’s situation, route information, and potential hazards, thereby ensuring a more intuitive and supportive navigation experience.

A method for user-customized dynamic prompting for walking guidance according to an embodiment may include generating a text prompt to be input to a vision-language model based on real-time sensor information and history information pertaining to a user and obtaining walking guidance information by inputting an image capturing a walking environment, destination information within the image, and the text prompt to the vision-language model.

Here, the real-time sensor information may be stored as user-specific history information by being delivered to a profile database that stores user information.

Here, the real-time sensor information may include a user ID, the current walking speed of the user, and the current position information of the user.

Here, the history information may include at least one of an average walking speed per user ID, a walking route, which is information about whether a route is a routine route or a new route, a list of places to avoid, or a list of walking guidance modification requests, or a combination thereof.

Here, the list of places to avoid may include places disliked by the user or dangerous places and may be manually designated by the user or automatically designated based on map information or feedback information from the user.

Here, the prompt may include a system prompt, which includes the real-time sensor information, the history information of the user, and an automatically generated walking guidance request message, and a user prompt, which includes a walking guidance request message containing the destination information within the image.

The method for user-customized dynamic prompting for walking guidance according to an embodiment may further include generating a mask image by extracting only a predetermined region of interest from the image based on a route to a destination, and obtaining the walking guidance information may comprise inputting a mask image corresponding to the generated text prompt to the vision-language model.

Here, the mask image may include at least one of a destination region mask image, a path region mask image, a left-of-path region mask image, or a right-of-path region mask image, or a combination thereof.

Here, generating the text prompt may comprise generating a text prompt corresponding to a result of the mask image.

Here, generating the mask image may comprise generating the mask image based on the image and the destination information of the user within the image.

An apparatus for user-customized dynamic prompting for walking guidance according to an embodiment may include a speed sensor for measuring the current walking speed of a user, a camera for capturing and outputting an image of a walking environment, a position sensor for measuring the current position of the user, a prompt engine for generating a text prompt to be input to a vision-language model based on real-time sensor information pertaining to the user, which is measured by the speed sensor and the position sensor, and on previously stored history information, and the vision-language model for outputting walking guidance information for the image, destination information within the image, and the text prompt.

Here, the real-time sensor information may be stored as user-specific history information by being delivered to a profile database that stores user information.

Here, the history information may include at least one of an average walking speed per user ID, a walking route, which is information about whether a route is a routine route or a new route, a list of places to avoid, or a list of walking guidance modification requests, or a combination thereof.

Here, the list of places to avoid may include places disliked by the user or dangerous places and may be manually designated by the user or automatically designated based on map information or feedback information from the user.

Here, the prompt may include a system prompt, which includes the real-time sensor information, the history information of the user, and an automatically generated walking guidance request message, and a user prompt, which includes a walking guidance request message containing the destination information within the image.

The apparatus for user-customized dynamic prompting for walking guidance according to an embodiment may further include a masking engine for generating a mask image by extracting only a predetermined region of interest from the image based on a route to a destination and for inputting the mask image to the vision-language model.

Here, the mask image may include at least one of a destination region mask image, a path region mask image, a left-of-path region mask image, or a right-of-path region mask image, or a combination thereof.

Here, the prompt engine may generate a text prompt corresponding to a result of the mask image.

Here, the masking engine generates the mask image based on the image and the destination information of the user within the image.

An apparatus for user-customized dynamic prompting for walking guidance includes memory in which at least one program is recorded and a processor for executing the program, and the program may generate a text prompt to be input to a vision-language model based on real-time sensor information and history information pertaining to a user, generate a mask image by extracting only a predetermined region of interest based on a route to a destination in an image, and obtain walking guidance information by inputting the mask image, information about the destination, and the text prompt to the vision-language model.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a schematic block diagram of a system including an apparatus for user-customized dynamic prompting for walking guidance according to an embodiment;

FIG. 2 is an exemplary view of real-time sensor information and user history information for walking guidance according to an embodiment;

FIGS. 3 and 4 are exemplary views of input/output of a vision-language model according to an embodiment;

FIGS. 5 and 6 are exemplary views of prompt generation associated with a masking engine according to an embodiment;

FIG. 7 is a flowchart for explaining a method for user-customized dynamic prompting for walking guidance according to an embodiment; and

FIG. 8 is a view illustrating a computer system configuration according to an embodiment.

### DESCRIPTION OF THE PREFERRED EMBODIMENTS

The advantages and features of the present disclosure and methods of achieving them will be apparent from the following exemplary embodiments to be described in more detail with reference to the accompanying drawings. However, it should be noted that the present disclosure is not limited to the following exemplary embodiments, and may be implemented in various forms. Accordingly, the exemplary embodiments are provided only to disclose the present disclosure and to let those skilled in the art know the category of the present disclosure, and the present disclosure is to be defined based only on the claims. The same reference numerals or the same reference designators denote the same elements throughout the specification.

It will be understood that, although the terms “first,” “second,” etc. may be used herein to describe various elements, these elements are not intended to be limited by these terms. These terms are only used to distinguish one element from another element. For example, a first element discussed below could be referred to as a second element without departing from the technical spirit of the present disclosure.

The terms used herein are for the purpose of describing particular embodiments only and are not intended to limit the present disclosure. As used herein, the singular forms are intended to include the plural forms as well, unless the context clearly indicates otherwise. It will be further understood that the terms “comprises,” “comprising,”, “includes” and/or “including,” when used herein, specify the presence of stated features, integers, steps, operations, elements, and/or components, but do not preclude the presence or addition of one or more other features, integers, steps, operations, elements, components, and/or groups thereof.

Unless differently defined, all terms used herein, including technical or scientific terms, have the same meanings as terms generally understood by those skilled in the art to which the present disclosure pertains. Terms identical to those defined in generally used dictionaries should be interpreted as having meanings identical to contextual meanings of the related art, and are not to be interpreted as having ideal or excessively formal meanings unless they are definitively defined in the present specification.

Recently, images and Visual Question Answering (VQA) technologies using Vision Language Model (VLM) technology have opened up the possibility of providing more intuitive and efficient walking guidance by analyzing user’s visual information.

VLMs facilitate generation of appropriate guidance messages by understanding the current position and surrounding environment of a user through interaction between images and text. Accordingly, the user may more naturally and safely reach a destination even when a walking route is complex.

The present disclosure proposes an apparatus and method for generating user-customized dynamic prompts for a VLM, such as GPT-4, for walking guidance.

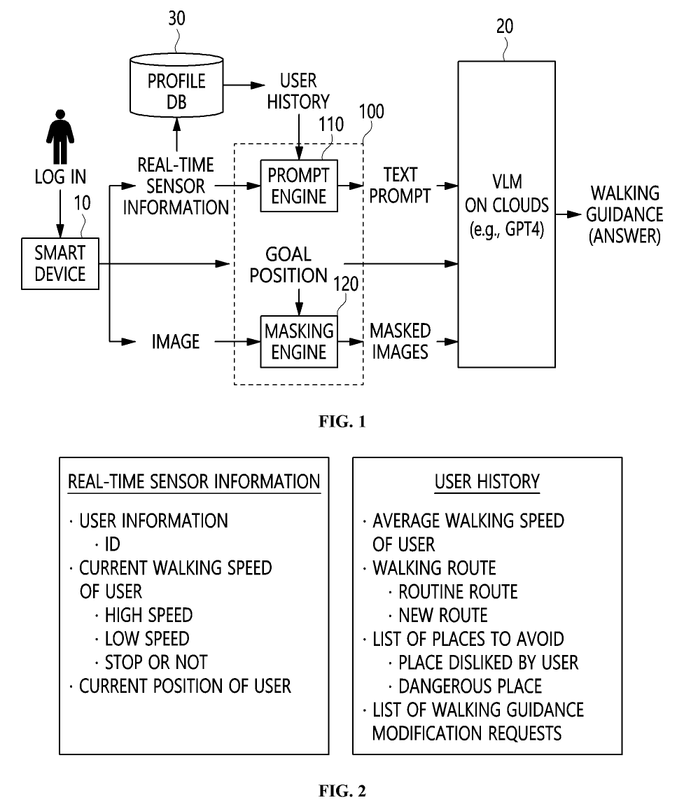

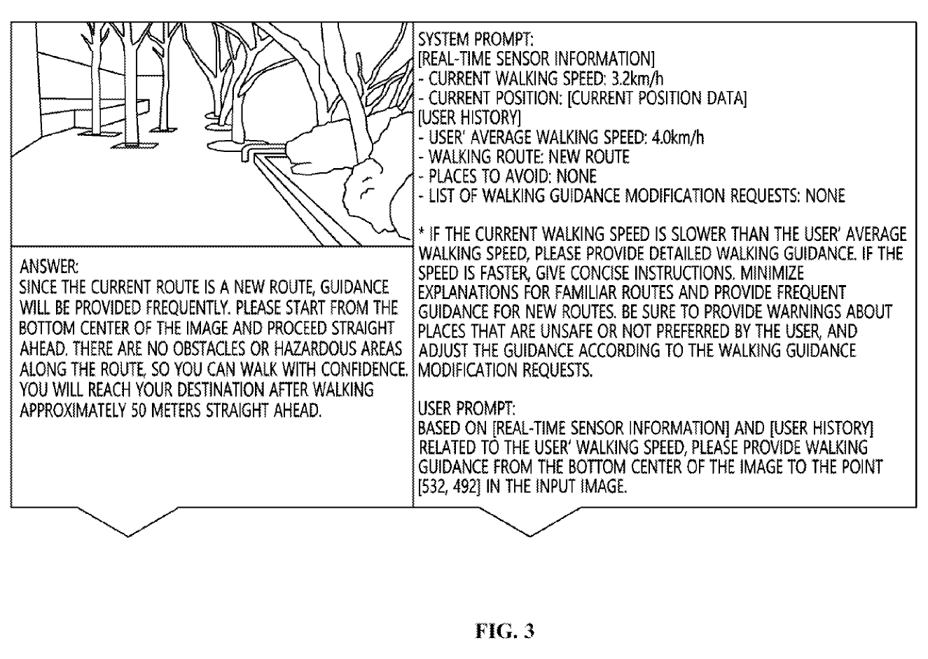

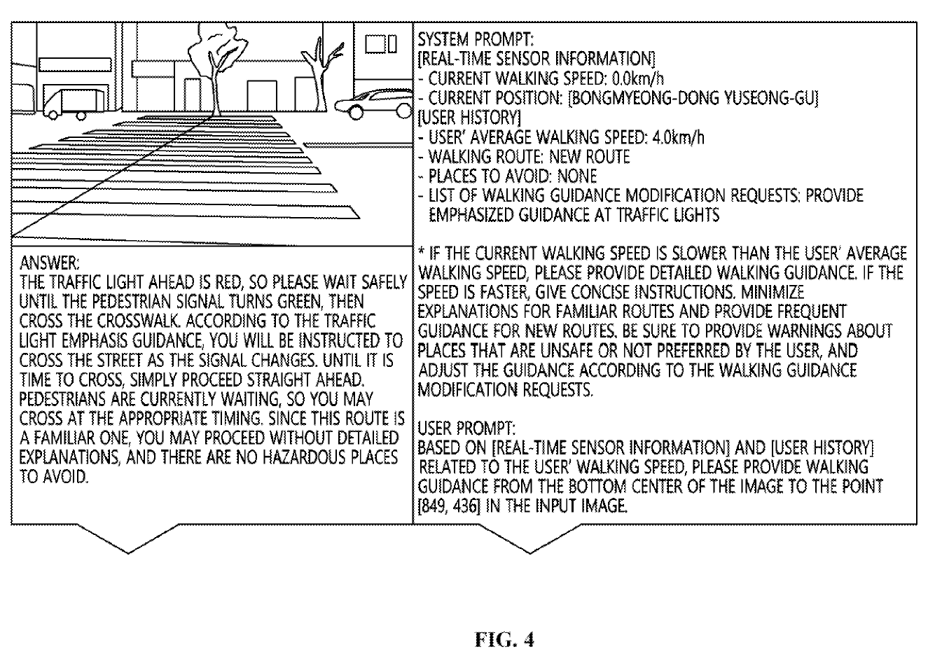

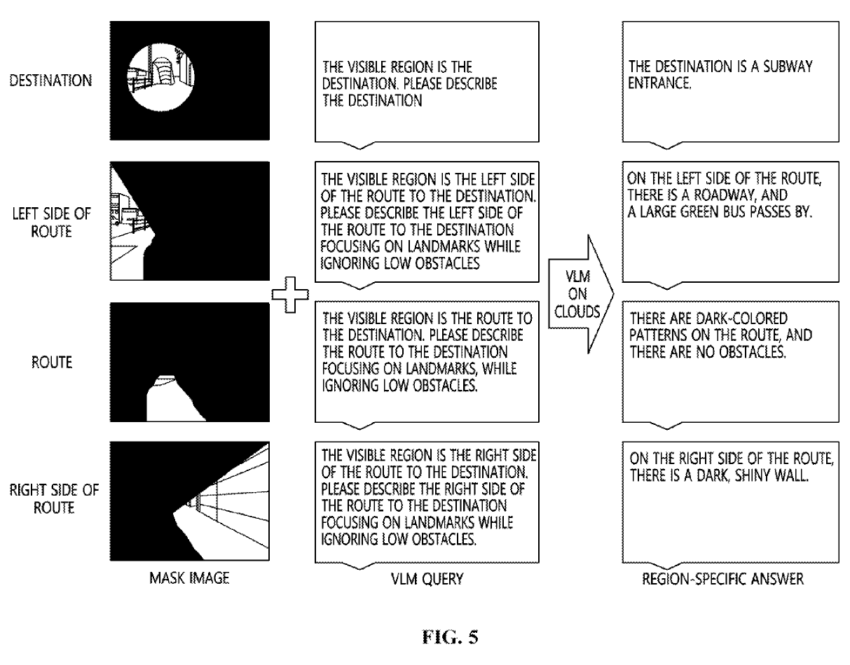

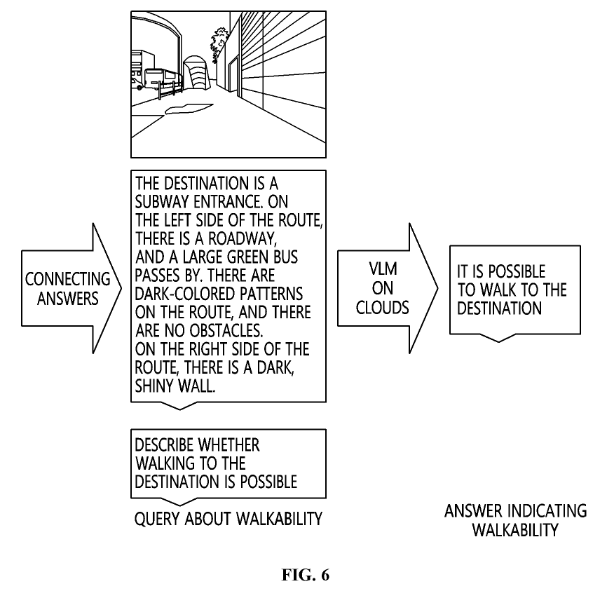

FIG. 1 is a schematic block diagram of a system including an apparatus for user-customized dynamic prompting for walking guidance according to an embodiment, FIG. 2 is an exemplary view of real-time sensor information and user history information for walking guidance according to an embodiment, FIGS. 3 and 4 are exemplary views of input/output of a vision-language model according to an embodiment, and FIGS. 5 and 6 are exemplary views of prompt generation associated with a masking engine according to an embodiment.

Referring to FIG. 1, the apparatus 100 for user-customized dynamic prompting for walking guidance according to an embodiment (referred to as the ‘apparatus’ hereinafter) may be implemented to operate in conjunction with a smart device 10 and a Vision Language Model (VLM) 20.

Although the smart device 10 and the apparatus 100 are illustrated as separate components in FIG. 1, the present disclosure is not limited thereto. That is, the apparatus 100 may be alternatively configured to operate within the smart device 10.

The apparatus 100 may provide a walking guidance message using the smart device 10 carried by a user.

Here, the smart device 10 is a device including an Inertial Measurement Unit (IMU) for measuring the walking speed of the user, a camera for capturing an image of a walking environment, a GPS sensor for tracking the current position of the pedestrian, and the like, and a smartphone may be a representative example of the smart device 10.

That is, the apparatus 100 analyzes the current situation of the user and focuses on providing a walking guidance message suitable for various conditions, including the walking environment, individual characteristics, and preferences of the user. As a result, the user may safely and efficiently reach a destination even in a complex walking environment.

The VLM 20 may receive an image captured by the camera, information about a destination (goal position) within the image, and a text prompt and generate walking guidance as an answer.

Here, the VLM 20 may use a cloud-based VLM, such as GPT-4, or a local model.

Here, the information about the destination (goal position) within the image, that is, (x, y) coordinates in the image, may be regarded as a local destination for a global destination and may be regarded as being projected onto the image. In an embodiment, a description will be made on the assumption that the destination is included in the image.

The apparatus 100 according to an embodiment may include a prompt engine 110 and a masking engine 120.

The prompt engine 110 generates a text prompt to be input to the vision-language model based on real-time sensor information and user history information pertaining to the user who is walking, which are received from the smart device 10 and a profile DB 30, respectively.

Here, the real-time sensor information may be stored as user-specific history information by being delivered to the profile DB 30, which stores long-term and mid-term information of the user.

The profile DB 30 may use storage within the smart device or a cloud.

Referring to FIG. 2, the real-time sensor information may include a user ID, the current walking speed of the user, and the current position information of the user.

Also, the user history information includes at least one of an average walking speed per user ID, information about whether the walking route is a routine route or a new route, a list of places to avoid, or a list of walking guidance modification requests, or a combination thereof.

Here, the walking route frequently used may be set as a routine route by the user or through processing, and the other routes may be set as new routes.

The list of places to avoid includes places disliked by the user or dangerous places, and it may be manually designated by the user or automatically designated based on map information or feedback information from the user.

The list of walking guidance modification requests is a list stored in a DB, to which the preferences of the user can be reflected after the user receives guidance from the VLM 20.

For example, the list of walking guidance modification requests may store in a text form, user request information such as “Give more emphasis at traffic lights”, “Make all instructions short and simple”, and “Provide detailed explanations for new routes”.

Meanwhile, the prompt engine 110 may construct a system prompt and a user prompt and output the same as shown on the right sides of FIGS. 3 and 4.

Here, the system prompt includes the real-time sensor information and the user history information and includes a prompt that allows the VLM to appropriately generate an answer.

Also, the user prompt includes a walking guidance request message by including the information about the destination (goal position) within the image.

That is, when the image illustrated on the upper-left side and the text prompt illustrated on the right side of FIGS. 3 and 4 are input to the VLM 20, the VLM 20 outputs the answer illustrated on the lower-left side as a result.

Meanwhile, the masking engine 120 illustrated in FIG. 1 may generate a mask image by extracting only a predetermined region of interest based on the route to the destination (goal position) in the image and input the mask image to the vision-language model 20.

Here, the mask image may include at least one of a destination region mask image, a path region mask image, a left-of-path region mask image, or a right-of-path region mask image, or a combination thereof. Through the region-specific mask images, the spatial understanding of the VLM 20 toward the destination may be improved.

Here, the prompt engine 110 may operate in conjunction with the masking engine 120. In this case, prompts may be generated to correspond to the respective image results of the masking engine 120, as illustrated in FIGS. 5 and 6.

Also, when the prompt engine 110 does not operate in conjunction with the masking engine 120, the image that is not masked may be input to the VLM 20 without change.

Meanwhile, the masking engine 120 may generate a mask image based on the image and information about the user’s destination (goal position) within the image.

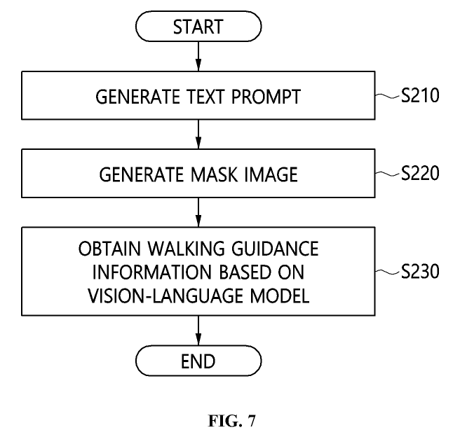

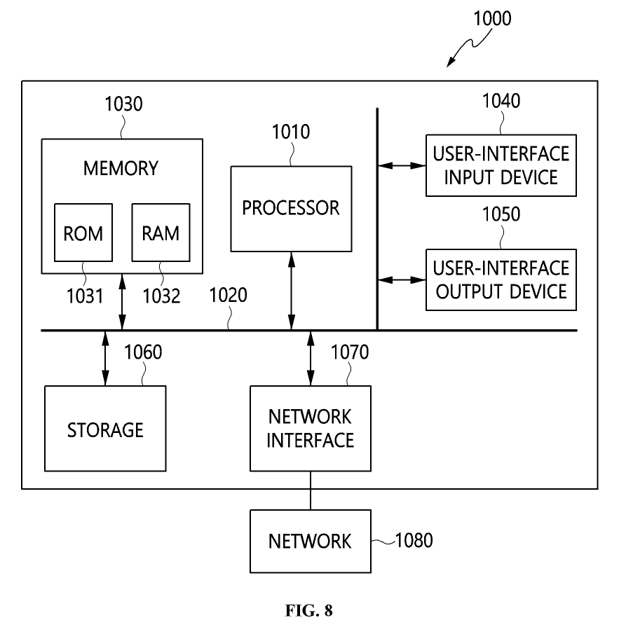

FIG. 7 is a flowchart for explaining a method for user-customized dynamic prompting for walking guidance according to an embodiment.

Referring to FIG. 7, the method for user-customized dynamic prompting for walking guidance according to an embodiment may include generating a text prompt to be input to a vision-language model based on real-time sensor information and history information pertaining to a user at step S210 and obtaining walking guidance information by inputting an image capturing a walking environment, destination information within the image, and the text prompt to the vision-language model at step S230.

Here, the real-time sensor information may be stored as user-specific history information by being delivered to a profile database for storing user information.

Here the real-time sensor information may include a user ID, the current walking speed of the user, and the current position information of the user.

Here, the history information may include at least one of an average walking speed per user ID, a walking route, which is information about whether a route is a routine route or a new route, a list of places to avoid, or a list of walking guidance modification requests, or a combination thereof.

Here, the list of places to avoid includes places disliked by the user or dangerous places and may be manually designated by the user or automatically designated based on map information or feedback information from the user.

Here, the prompt may include a system prompt, which includes the real-time sensor information, the user history information, and an automatically generated walking guidance request message, and a user prompt, which includes a walking guidance request message containing the destination information within the image.

The method for user-customized dynamic prompting for walking guidance according to an embodiment further includes generating a mask image by extracting only a predetermined region of interest based on the route to the destination in the image at step S220, and obtaining the walking guidance information at step S230 may comprise inputting a mask image corresponding to the generated text prompt to the vision-language model.

Here, the mask image may include at least one of a destination region mask image, a path-region mask image connecting left-side and right-side points of the route, a left-of-path region mask image connecting the upper-left and lower-left points and the left-side points of the walking route, or a right-of-path region mask image connecting the upper-right and lower-right points and the right-side points of the walking route, or a combination thereof.

Here, generating the text prompt at step S210 may comprise generating a text prompt corresponding to a result of the mask image.

Here, generating the mask image at step S220 may comprise generating a mask image based on the image and information about the user’s destination (goal position) within the image.

FIG. 8 is a view illustrating a computer system configuration according to an embodiment.

The smart device 10 and the apparatus 100 for user-customized dynamic prompting for walking guidance according to an embodiment may be implemented in a computer system 1000 including a computer-readable recording medium.

The computer system 1000 may include one or more processors 1010, memory 1030, a user-interface input device 1040, a user-interface output device 1050, and storage 1060, which communicate with each other via a bus 1020. Also, the computer system 1000 may further include a network interface 1070 connected with a network 1080. The processor 1010 may be a central processing unit or a semiconductor device for executing a program or processing instructions stored in the memory 1030 or the storage 1060. The memory 1030 and the storage 1060 may be storage media including at least one of a volatile medium, a nonvolatile medium, a detachable medium, a non-detachable medium, a communication medium, or an information delivery medium, or a combination thereof. For example, the memory 1030 may include ROM 1031 or RAM 1032.

According to the disclosed embodiment, when providing guidance on a walking route in a complex and dynamic environment, various factors, such as a user’s situation, route information, and potential hazards, are taken into account, whereby it is possible to improve the effectiveness and suitability of the walking route guidance and ensure a more intuitive and supportive navigation experience.

Although embodiments of the present disclosure have been described with reference to the accompanying drawings, those skilled in the art will appreciate that the present disclosure may be practiced in other specific forms without changing the technical spirit or essential features of the present disclosure. Therefore, the embodiments described above are illustrative in all aspects and should not be understood as limiting the present disclosure.

What is claimed is:

1. A method for user-customized dynamic prompting for walking guidance, comprising:
generating a text prompt to be input to a vision-language model based on real-time sensor information and history information pertaining to a user; and
obtaining walking guidance information by inputting an image capturing a walking environment, destination information within the image, and the text prompt to the vision-language model.

2. The method of claim 1, wherein the real-time sensor information is stored as user-specific history information by being delivered to a profile database that stores user information.

3. The method of claim 1, wherein the real-time sensor information includes a user ID, a current walking speed of the user, and current position information of the user.

4. The method of claim 1, wherein the history information includes at least one of an average walking speed per user ID, a walking route, which is information about whether a route is a routine route or a new route, a list of places to avoid, or a list of walking guidance modification requests, or a combination thereof.

5. The method of claim 4, wherein the list of places to avoid includes places disliked by the user or dangerous places and is manually designated by the user or automatically designated based on map information or feedback information from the user.

6. The method of claim 1, wherein the prompt includes a system prompt, which includes the real-time sensor information, the history information of the user, and an automatically generated walking guidance request message, and a user prompt, which includes a walking guidance request message containing the destination information within the image.

7. The method of claim 1, further comprising:
generating a mask image by extracting only a predetermined region of interest from the image based on a route to a destination,
wherein obtaining the walking guidance information comprises inputting a mask image corresponding to the generated text prompt to the vision-language model.

8. The method of claim 7, wherein the mask image includes at least one of a destination region mask image, a path region mask image, a left-of-path region mask image, or a right-of-path region mask image, or a combination thereof.

9. The method of claim 8, wherein generating the text prompt comprises generating a text prompt corresponding to a result of the mask image.

10. The method of claim 7, wherein generating the mask image comprises generating the mask image based on the image and the destination information of the user within the image.

11. An apparatus for user-customized dynamic prompting for walking guidance, comprising:
a speed sensor for measuring a current walking speed of a user;
a camera for capturing and outputting an image of a walking environment;
a position sensor for measuring a current position of the user;
a prompt engine for generating a text prompt to be input to a vision-language model based on real-time sensor information pertaining to the user, which is measured by the speed sensor and the position sensor, and on previously stored history information; and
the vision-language model for outputting walking guidance information for the image, destination information within the image, and the text prompt.

12. The apparatus of claim 11, wherein the real-time sensor information is stored as user-specific history information by being delivered to a profile database that stores user information.

13. The apparatus of claim 11, wherein the history information includes at least one of an average walking speed per user ID, a walking route, which is information about whether a route is a routine route or a new route, a list of places to avoid, or a list of walking guidance modification requests, or a combination thereof.

14. The apparatus of claim 13, wherein the list of places to avoid includes places disliked by the user or dangerous places and is manually designated by the user or automatically designated based on map information or feedback information from the user.

15. The apparatus of claim 11, wherein the prompt includes a system prompt, which includes the real-time sensor information, the history information of the user, and an automatically generated walking guidance request message, and a user prompt, which includes a walking guidance request message containing the destination information within the image.

16. The apparatus of claim 11, further comprising:
a masking engine for generating a mask image by extracting only a predetermined region of interest from the image based on a route to a destination and for inputting the mask image to the vision-language model.

17. The apparatus of claim 16, wherein the mask image includes at least one of a destination region mask image, a path region mask image, a left-of-path region mask image, or a right-of-path region mask image, or a combination thereof.

18. The apparatus of claim 16, wherein the prompt engine generates a text prompt corresponding to a result of the mask image.

19. The apparatus of claim 16, wherein the masking engine generates the mask image based on the image and the destination information of the user within the image.

20. An apparatus for user-customized dynamic prompting for walking guidance, comprising:
memory in which at least one program is recorded; and
a processor for executing the program,
wherein the program generates a text prompt to be input to a vision-language model based on real-time sensor information and history information pertaining to a user, generates a mask image by extracting only a predetermined region of interest based on a route to a destination within an image capturing a walking environment, and obtains walking guidance information by inputting the mask image, information about the destination, and the text prompt to the vision-language model.
